(19) United States
(12) Patent Application Publication
(10) Pub. No.: US 2019/0176782 A1
(43) Pub. Date: Jun. 13, 2019

(54) Emergency Break Cable Tension Adjustment Devices and Methods

(71) Applicant: Rapidan River Industries,LLC, Rixeyville, VA (US)

(72) Inventor: David Lewis Quinn, Rixeyville, VA (US)

(73) Assignee: Rapidan River Industries, LLC, Rixeyville, VA (US)

(21) Appl. No.: 16/212,814

(22) Filed: Dec. 7, 2018

Related U.S. Application Data
(60) Provisional application No. 62/595,839, filed on Dec. 7, 2017.

(51) Int. Cl. B60T 7/10; B60T 11/04; F16D 65/28; F16C 1/22

(52) U.S. Cl. CPC B60T 7/108; B60T 11/046; F16D 2125/62; F16C 1/22; F16D 65/28

(57) ABSTRACT

Methods and devices for tensioning a cable are disclosed. The device comprises a nut having two open ends, two bolts, each bolt having a central bore and adapted to mate with one open end of the nut, and two cable securement devices. The cable securement devices are smaller than an inner diameter of the nut and larger than a diameter of the central bores of the bolts.

### REFERENCE TO RELATED APPLICATION

This application claims priority to U.S. Provisional Application No. 62/595,239 entitled “Emergency Break Cable Tension Adjustment Devices and Methods” filed Dec. 7, 2017, which is entirely incorporated by reference.

### BACKGROUND

### 1. Field of the Invention

This invention is directed to devices and methods for tensioning emergency break cables. Specifically, the invention is directed to devices and methods for tensioning loose emergency break cables without replacing the cable.

### 2. Description of the Background

In road vehicles, the emergency brake, also called hand brake, parking brake, or e-brake, is used to keep the vehicle stationary and in many cases also perform an emergency stop. Emergency brakes on older vehicles often consist of a cable connected to two-wheel brakes at one end and the other end to a pulling mechanism which is operated by the driver's hand or foot. The mechanism may be a hand-operated lever, at floor level beside the driver, or a straight pull handle located near the steering column, or a (foot-operated) pedal located beside the driver's leg. In most automobiles the emergency brake operates only on the rear wheels, which have reduced traction while braking. However, some automobiles have the emergency brake operate on the front wheels.

The most common use for an emergency brake is to keep a vehicle motionless when it is parked. The emergency brake may have a ratchet or other locking mechanism that will keep it engaged until manually released. On vehicles with automatic transmissions, this is usually used in concert with a parking pawl in the transmission.

Over time, the emergency break cable may stretch out and loose tension. Once stretched, the cable may not perform correctly or be able to properly lock the wheels. Typically, a mechanic or owner of the car will have to replace the cable which can be a costly and time-consuming endeavor. Therefore, there is a desire to re-tension the cable without replacing the cable.

### SUMMARY

The present invention overcomes the problems and disadvantages associated with current strategies and designs and provides new tools and methods for tensioning emergency break cables.

One embodiment of the invention is directed to a device for tensioning a cable. The device comprises a nut having two open ends, two bolts, each bolt having a central bore and adapted to mate with one open end of the nut, and two cable securement devices. The cable securement devices are smaller than an inner diameter of the nut and larger than a diameter of the central bores of the bolts.

Preferably, the device further comprises at least two spring washers, each spring washer adapted to be placed between a head of a bolt and the nut. The cable is preferably divided into two portions and the central bore of each bolt is adapted to receive an end of one portion of the cable and a cable securement device is adapted to secure the bolt to the portion of the cable. In a preferred embodiment, as the bolts are tightened into the nut, the two portions of the cable are drawn together, thereby tensioning the cable. Preferably, the cable securement device is a c-washer. The cable is preferably an emergency break cable. The device is preferably adapted to tension an existing emergency break cable.

Another embodiment of the invention is directed to a method of tensioning a cable with two free ends. The method comprises the steps of threading each free end through a bolt having a borehole, securing each free end of the cable to the bolt with a cable securement device, and inserting both bolts into a single nut, wherein as the bolts a tightened, the free ends of the cable are drawn together, thereby tensioning the cable.

Preferably, the method further comprises the step of placing a spring washer between a head of a bolt and the nut prior to assembly. The cable securement device is preferably a c-washer. Preferably, the cable is an emergency break cable. In a preferred embodiment, the device is adapted to tension an existing emergency break cable. The method preferably further comprises the step of removing a factory installed cable joiner/crimp. Preferably, the cable securement devices are smaller than an inner diameter of the nut and larger than a diameter of the central bores of the bolts.

Other embodiments and advantages of the invention are set forth in part in the description, which follows, and in part, may be obvious from this description, or may be learned from the practice of the invention.

### DESCRIPTION OF THE FIGURES

FIG. 1 An exploded view of an embodiment of the emergency break tensioning device.

FIG. 2 A translucent assembled view of an embodiment of the emergency break tensioning device.

FIGS. 3A-D Views of the individual components of the emergency break tensioning device.

FIG. 4 A view of a disassembled emergency break cable.

FIG. 5 An embodiment of the emergency break tensioning device being installed on the emergency break cable.

FIG. 6 An embodiment of the emergency break tensioning device being installed on the emergency break cable.

FIG. 7 An embodiment of the emergency break tensioning device being installed on the emergency break cable.

FIGS. 8A-B An embodiment of the emergency break tensioning device being installed on the emergency break cable.

FIG. 9 An embodiment of the emergency break tensioning device installed on the emergency break cable.

### DESCRIPTION OF THE INVENTION

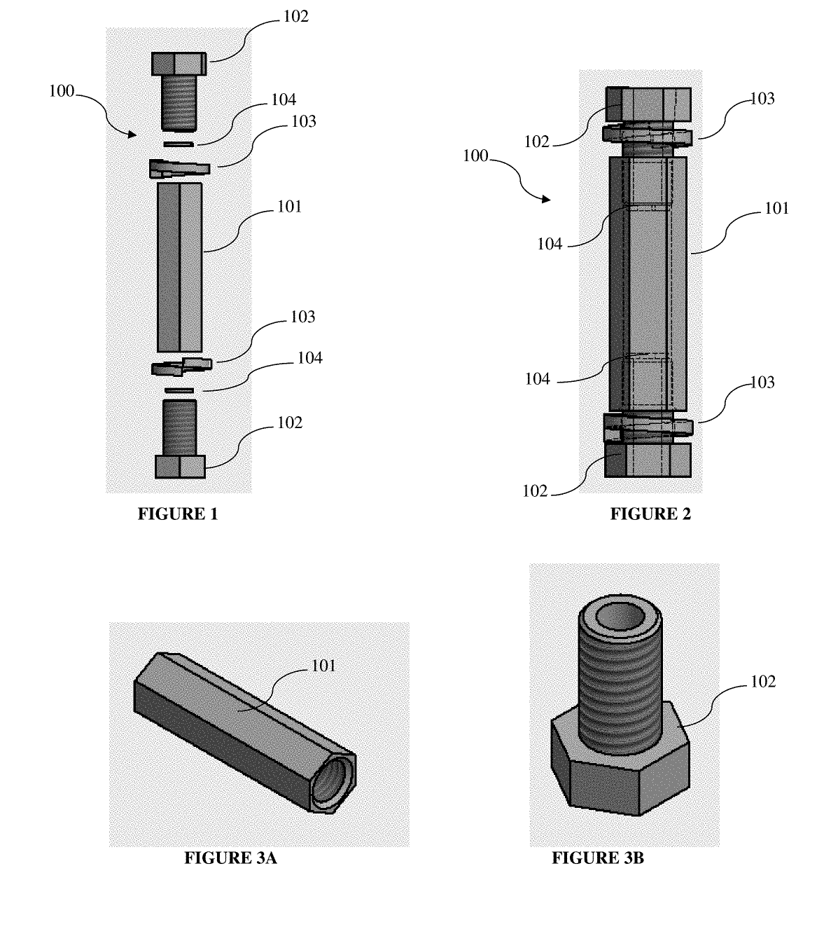

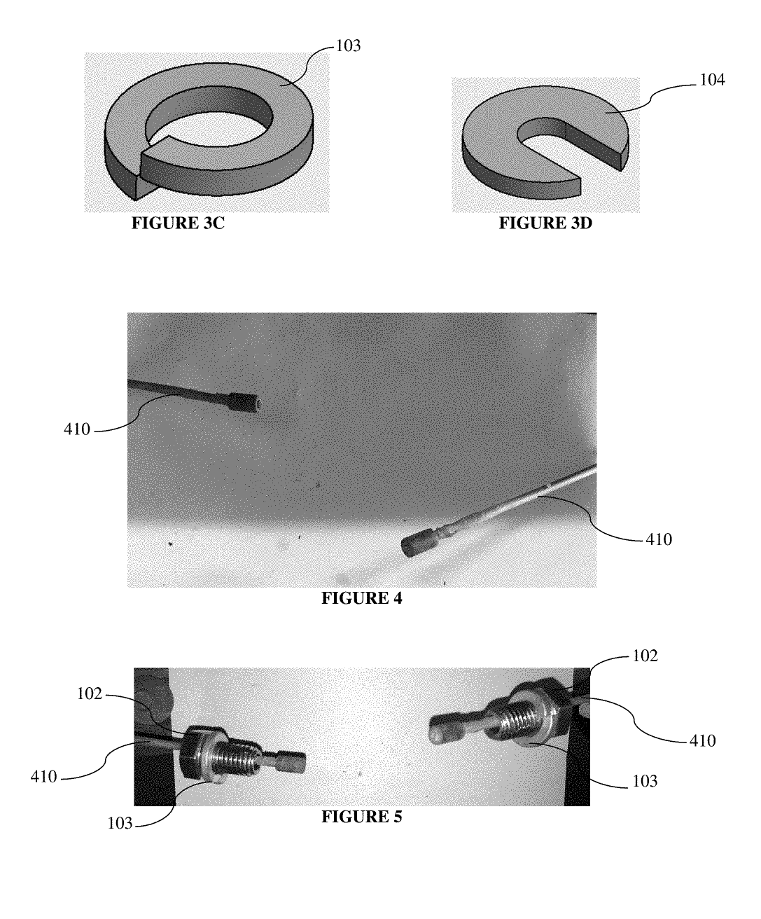

FIG. 1 depicts an exploded view of a preferred embodiment of the emergency break tensioning device 100. Device 100 is preferably comprised of a central long nut 101 (see FIG. 3A). Preferably nut 101 has a standard hexagonal outer surface. For example, the outer surface of nut 101 may be ⅝″, 9/16″, ½″, ¾″, or another dimension. Furthermore, the outer surface of nut 101 may be a standard metric size. Preferably, nut 101 is 3″ long, however nut 101 may have another length. For example, nut 101 may be 2″, 2.5″, 3.5″, or 4″ long. The interior surface of nut 101 is preferably threaded. For example, nut 101 may have 11 tpi (teeth-per-inch), 10 tpi, 12 tpi, or another number of teeth-per-inch.

Bolts 102 (see FIG. 3B) area preferably adapted to be threaded into nut 101. Bolts 102 preferably have standard hexagonal heads. For example, the heads of bolts 102 may be ⅝″, 9/16″, ½″, ¾″, or another dimension. Furthermore, the heads of bolts 102 may be a standard metric size. Preferably, bolts 102 are 1″ long, however bolts may have another length. For example, bolts may be ½″, ¾″, 1¼″, or 1½″ long. The shanks of bolts 102 are preferably threaded. For example, bolts 102 may have 11 tpi (teeth-per-inch), 10 tpi, 12 tpi, or another number of teeth-per-inch. Preferably, the threading of nut 101 matches the threading of bolts 102. Preferably, nut 101 and bolts 102 are standard US sized nuts and bolts of ⅝″ with 11 tpi. Preferably, bolts 102 have a central bore drill through the head and shank of each bolt. The bore may have a 11/32″ diameter 5/16″ diameter, ⅜″ diameter or another diameter.

Device 100 may also have two or more spring washers 103 (see FIG. 3C) and two or more c-washers 104 (see FIG. 3D). Preferably, when assembled, each side of device 100 has an equal number of spring washers 103 and an equal number of c-washer 104. Spring washers 103 preferably are standard sized spring washers that match the size of nut 101 and bolts 102. For example, spring washers 103 may be ⅝″, 9/16″, ½″, ¾″, or another dimension. C-washers 104 preferably have a larger outer diameter than the bore hole in bolts 102 and a smaller diameter than the inner diameter of nut 101, such that c-washers 104 fit inside nut 101 but cannot fit through bolts 102. For example, c-washers 104 may have an outer diameter of ½″, 7/16″, or 9/16″. Additionally, c-washers 104 preferably have an inner diameter slightly larger than the diameter of an emergency break cable, such that the emergency break cable can sit within c-washer 104. For example, the inner diameter of c-washer 104 may be 11/64″, 3/16″, or 13/64″. Preferably, c-washers 104 are made from 16-gauge material, however another thickness material can be used.

Preferably the components of device 100 are rust resistant, able to withstand conditions faced by automobiles (e.g. rain, snow, salt, chemicals, wind, dirt, sand, and hot and cold temperatures). The components of device 100 are preferably made of zinc coated steel, stainless steel, brass, galvanized steel, still with other anti-wear or anti-rust coatings, aluminum, silicone bronze, plastic, nylon, rubber, carbon fiber, another high strength anti-corrosion materials, or combinations thereof. Preferably, all of the components are made of the same material, however different components may be made of different materials. The components may be custom or off the shelf and hand-made or machine-made.

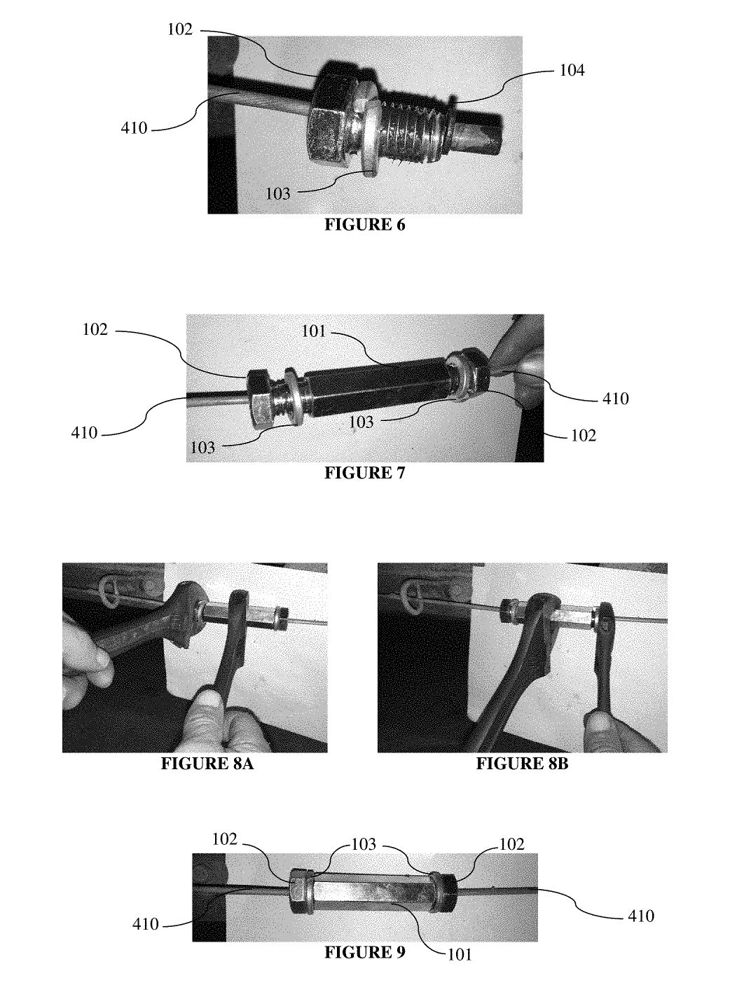

In order to retrofit device 100 onto an existing break line, the factory installed cable joiner/crimp is removed where the emergency break cable sections meet. As shown in FIG. 4, the ends of the two sections of the existing break line 410 are exposed and free. Each end of existing break line 410 is preferably inserted into the hole of a bolt 102 and a spring washer 103 is placed over the threads of bolt 102, as shown in FIG. 5. Alternatively, spring washers 103 can be added after c-washers 104. Preferably, at least one c-washer 104 is placed over each existing break line 410, between bolt 102 and the lug end of the existing break line 410, as show in FIG. 6. The c-washers 104 may be pinched between the lug end of the existing break line 410 and bolt 102 to prevent c-washers 104 from falling off during assembly. Nut 101 is preferably then screwed onto each bolt 102 as shown in FIG. 7. As shown in FIGS. 8A and 8B, nut 101 and bolts 102 are tightened (preferably to 60 ft-lbs torque) to complete the assembly of device 100, as shown in FIG. 9. As nut 101 and bolts 102 are tightened, existing break line 410 ends are pulled together, thereby tensioning the break line. While the assembly is described in a certain order, other orders of assembling are envisioned. For example, one side of device 100 can be assembled prior to the second side of device 100 being assembled.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. The term comprising, where ever used, is intended to include the terms consisting and consisting essentially of. Furthermore, the terms comprising, including, and containing are not intended to be limiting. It is intended that the specification and examples be considered exemplary only with the true scope and spirit of the invention indicated by the following claims.

1. A device for tensioning a cable, comprising:
a nut having two open ends;
two bolts, each bolt having a central bore and adapted to mate with one open end of the nut; and
two cable securement devices;
wherein the cable securement devices are smaller than an inner diameter of the nut and larger than a diameter of the central bores of the bolts.

2. The device of claim 1, further comprising at least two spring washers, each spring washer adapted to be placed between a head of a bolt and the nut.

3. The device of claim 1, wherein the cable is divided into two portions, the central bore of each bolt is adapted to receive an end of one portion of the cable and a cable securement device is adapted to secure the bolt to the portion of the cable.

4. The device of claim 3, wherein as the bolts are tightened into the nut, the two portions of the cable are drawn together, thereby tensioning the cable.

5. The device of claim 1, wherein the cable securement device is a c-washer.

6. The device of claim 1, wherein the cable is an emergency break cable.

7. The device of claim 6, wherein the device is adapted to tension an existing emergency break cable.

8. A method of tensioning a cable with two free ends, comprising the steps of:
threading each free end through a bolt having a borehole;
securing each free end of the cable to the bolt with a cable securement device;
inserting both bolts into a single nut, wherein as the bolts a tightened, the free ends of the cable are drawn together, thereby tensioning the cable.

9. The method of claim 8, further comprising placing a spring washer between a head of a bolt and the nut prior to assembly.

10. The method of claim 8, wherein the cable securement device is a c-washer.

11. The method of claim 8, wherein the cable is an emergency break cable.

12. The method of claim 11, wherein the device is adapted to tension an existing emergency break cable.

13. The method of claim 12, further comprising removing a factory installed cable joiner/crimp.

14. The method of claim 8, wherein the cable securement devices are smaller than an inner diameter of the nut and larger than a diameter of the central bores of the bolts.
